(19) United States
(12) Patent Application Publication
(10) Pub. No.: US 2007/0044331 A1
(43) Pub. Date: Mar. 1, 2007

(54) Laser leveler with ultrasonic transmitter and receiver

(76) Inventors: Billy Yung, Chai Wan (HK); Benny Tang, Chai Wan (HK)

Correspondence Address: SHELDON MAK ROSE & ANDERSON PC, 225 SOUTH LAKE AVENUE, 9TH FLOOR, PASADENA, CA, 91101, US

(21) Appl. No.: 11/212,888

(22) Filed: Aug. 26, 2005

(51) Int. Cl. G01C 15/00

(52) U.S. Cl. 33/286

(57) ABSTRACT

A laser leveler includes an ultrasonic transmitter, an ultrasonic receiver and a computer for computing distances traveled by an ultrasonic signal emitted from the ultrasonic transmitter and reflected back to the ultrasonic receiver.

### BACKGROUND OF THE INVENTION

Laser levelers capable of generating a visible, low energy laser beam are becoming quite popular in the construction arts as valuable tools to define construction lines along vertical and horizontal surfaces. For example, laser levelers are used to define perfectly vertical plumb lines for walls, riser pipes and ducts and for the placement of perfectly horizontal ledges, shelves, pipes and ducts.

However the laser levelers of the prior art are deficient in several respects which reduces their over all efficiency to the user.

Accordingly, there is a need for an improved laser leveler which markedly increases the tool's capabilities and efficiency over similar laser levelers of the prior art.

### SUMMARY OF THE INVENTION

The invention satisfies this need. The invention is a laser leveler comprising an ultrasonic transmitter, an ultrasonic receiver and a computer for computing distances traveled by an electronic signal emitted from the ultrasonic transmitter and reflect back to the ultrasonic receiver.

### DRAWINGS

These and other features, aspects and advantages of the present invention will become better understood with reference to the following description, appended claims and accompanying drawings where:

FIG. 1 is a perspective view of a second embodiment of a laser leveler having features of the invention;

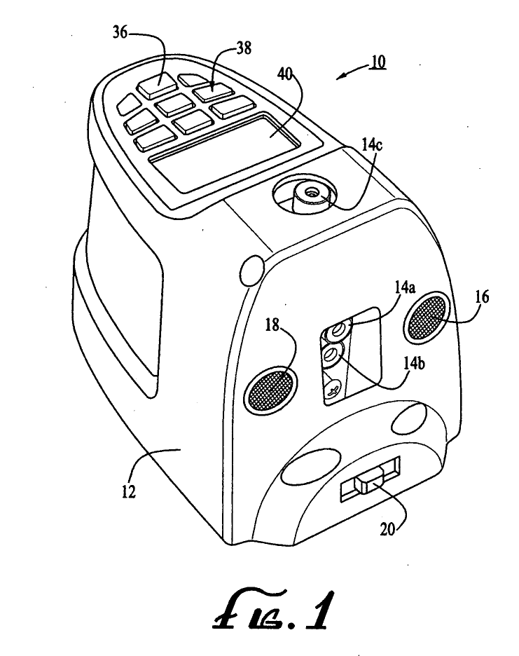

FIG. 2 is a perspective view of the laser leveler illustrated in FIG. 1, showing internal components;

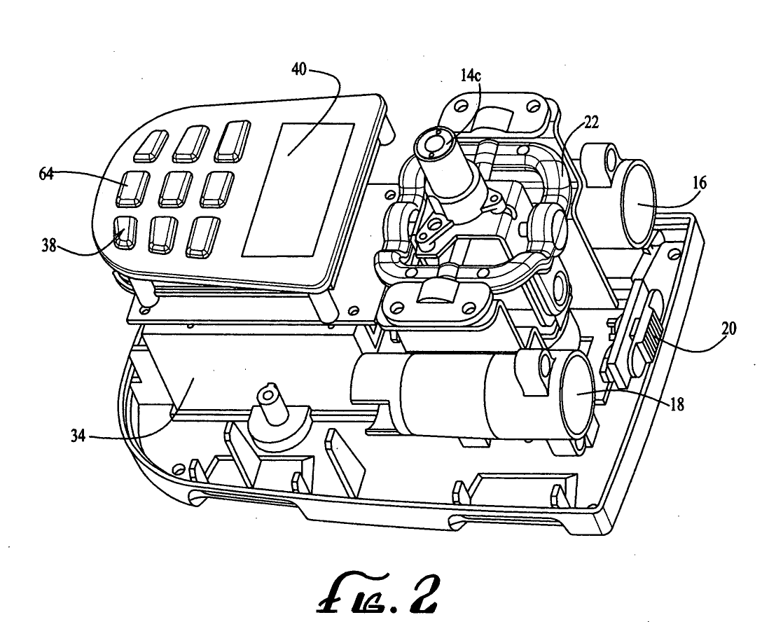

FIG. 3 is a second perspective view of the laser leveler illustrated in FIG. 1 showing internal components; and

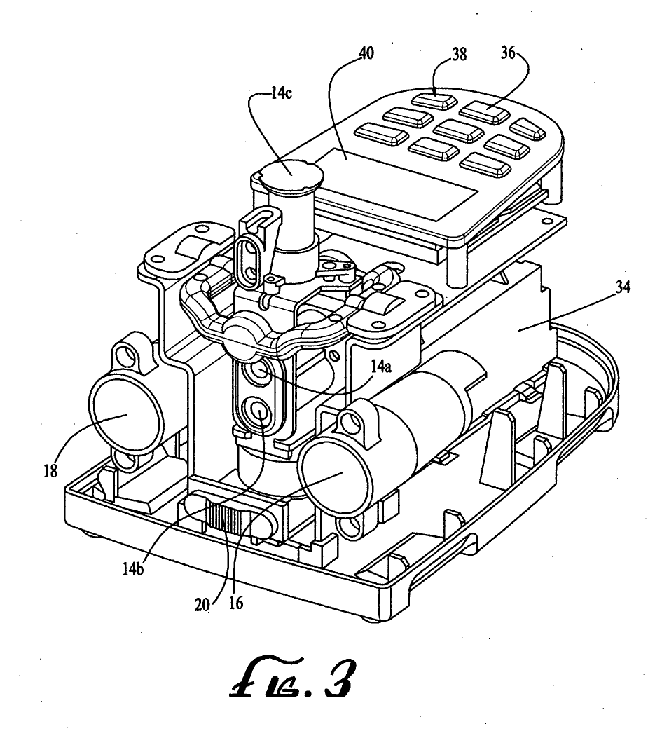

FIG. 4 is a perspective view of a pendulum device portion used in the laser leveler illustrated in FIG. 1.

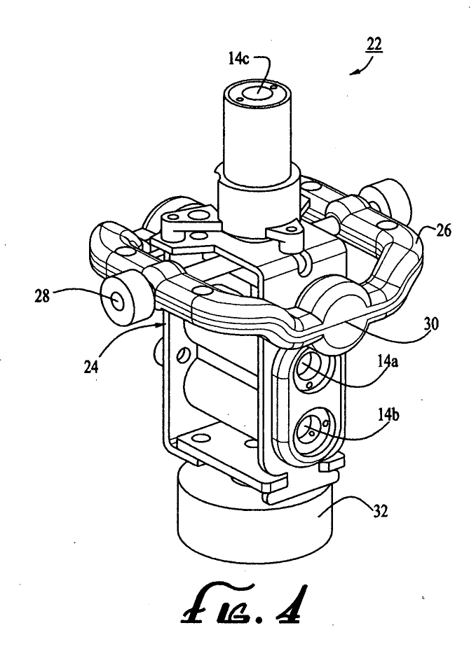

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The laser leveler 10 comprises a housing 12, three laser generating devices 14a, 14b and 14c, an ultrasonic transmitter 16, an ultrasonic receiver 18 and a lock switch 20.

Two of the three laser generating devices 14a and 14b are disposed horizontally within the housing 40. One of these horizontally disposed laser generating devices (14a) is capable of generating a vertical laser beam and the other (14b) is capable of generating a horizontal laser beam.

The third laser generating device (14c) is disposed vertically so as to provide a ceiling dot mark when the laser leveler 10 is disposed on a horizontal surface.

This invention further comprises an automatic leveling device 22, comprising a pendulum device 24. The pendulum device 24 comprises a mounting bracket 26, an X-axis shaft 28 and a Y-axis shaft 30. The pendulum device 24 further comprises a weight balance 32 disposed near the bottom of the pendulum device 24. The pendulum device 24 is supported by the X-axis shaft 28 and the Y-axis shaft 30 such that the pendulum device 24 is free to rotate in any X-axis or Y-axis horizontal directions. The weight balance 32 assures that the vertical axis of the pendulum device 24 is always disposed vertically.

Set screws (not shown) can be provided on each of the X and Y axes 28 and 30, respectively, to provide the ability to fine-tune the balancing of the pendulum device.

The lock switch 20 is provided near the bottom to alternatively lock or free the pendulum device 24.

The ultrasonic transmitter 16 and ultrasonic receiver 18 are mounted in the housing 12. The ultrasonic transmitter 16 is capable of transmitting ultrasonic waves and the ultrasonic receiver 18 is capable of receiving reflected ultrasonic waves. The ultrasonic transmitter 16 and the ultrasonic receiver 18 are operatively connected to a computer 34 for calculating the distance traveled by a reflected ultrasonic wave (based upon the travel time of the reflected wave).

The invention further comprises a main power switch 36, a keypad 38, and an LCD display 40.

The keypad 38 is used to select the several different functions of the laser leveler 10, including converting data between several different measuring systems, such as between metric and imperial measurement systems (using the computer 34).

The computer 34 comprises a memory unit, configured to control the emitting and receiving of ultrasonic waves, to store information and to compute distance, area, volume, either in metric units or in imperial measurement units.

In a typical operation, the user pushes a first button on the keypad to measure the length to an opposing wall. Preferably, the computer 34 is configured so that the distance to be measured is alternatively the forward surface of the laser leveler 10 or the rearward surface of the laser leveler 10.

To measure an area, the user takes a first distance measurement, presses a “store” button on the keypad 38, then presses a “read” button on the keypad 38 to measure a distance perpendicular to the first measured distance, and finally presses a “multiply” button on the keypad 38 to calculate the area defined by the two measured distances. To measure a volume, a third distance measurement is carried out perpendicular to the first two distance measurements and the “multiply” button on the keypad 38 is used to compute the volume defined by the three measured distances.

Typically, the computer 34 is powered by 3-volt direct current batteries, typically provided by a single 9-volt battery.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A laser leveler comprising an ultrasonic transmitter, an ultrasonic receiver and a computer for computing distances traveled by an electronic signal emitted from the ultrasonic transmitter and received by the ultrasonic receiver.

2. The laser leveler of claim 1 further comprising an LCD screen adapted to display distances calculated using ultrasonic signals sent from the ultrasonic transmitter and received back from the ultrasonic receiver.

3. The laser leveler of claim 1 wherein the computer is adapted to calculate area measurement from distance calculations in two directions disposed at right angles.

4. The laser leveler of claim 1 wherein the computer means is adapted to calculate area measurement from distance calculations in three directions, each disposed apart from one another by an angle of 90°.

5. The laser leveler of claim 1 wherein the computer is capable of toggling back and forth between at least two different linear measurement systems.
